(19) United States
(12) Patent Application Publication
(10) Pub. No.: US 2006/0210852 A1
(43) Pub. Date: Sep. 21, 2006

(54) Electrochemical preferential oxidation of carbon monoxide from reformate

(76) Inventors: Ravindra Datta, Worcester, MA (US); Jingxin Zhang, (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/566,405

(22) PCT Filed: Jul. 23, 2004
(86) PCT No.: PCT/US04/23889

§ 371 Date: Jan. 25, 2006

Related U.S. Application Data
(60) Provisional application No. 60/490,055, filed on Jul. 25, 2003.

(51) Int. Cl. H01M 8/04; H01M 8/10; H01M 8/12; H01M 4/96; H01M 4/94; H01M 8/24

(52) U.S. Cl. 429/23; 429/32; 429/44; 429/38; 429/13

(57) ABSTRACT

An electrochemical device comprises an electrochemical reactor that includes a single or multiple electrochemical cells and a galvanostat, a gas source and a fuel cell system. Each of the electrochemical cells includes an anode compartment and a cathode compartment. The gas source is in fluid communication with the anode or cathode compai ment of each of the electrochemical cells, including at least two components that are selectively reactive relative to each other. The selectivity of the two components of the gas source is dependent upon an electrical potential between an anode of the anode compartment and a cathode of the cathode compartment, whereby a constant current between the anode and cathode causes the electrical potential to oscillate autonomously while the gas components are directed through the anode or cathode compartment. The oscillation in potential causes autonomous oscillation of selective reaction of the gas components.

### RELATED APPLICATION

This application claims the benefit of U.S. Provisional Application No. 60/490,055, filed on Jul. 25, 2003. The entire teachings of the above application are incorporated herein by reference.

### BACKGROUND OF THE INVENTION

Methods for purifying a gas via electrochemical reactions of components of the gas, in which reaction activity and selectivity are controlled by electrical potential, have numerous applications. For example, electrochemical preferential oxidation of carbon monoxide (CO) can be used for purifying reformate that is used as a fuel source in proton-exchange membrane (PEM) fuel cells. The reformate needs proper and efficient purification, in particular removal of CO, which is a poison to electrocatalysts used in PEM fuel cells.

Despite the potential of PEM fuel cells to serve as power systems for a new generation of “green” vehicles, as well as off-road power plants operating with increased efficiency and reduced emissions, the use of hydrogen as the fuel source limits their immediate application as a power source. Since H₂ storage on site or on board vehicles is as yet impractical, conventional fuels, e.g., natural gas, gasoline or alcohols, are reformed catalytically into reformate that contains H₂ at the point of usage. However, the reformate typically contains substantial amounts of CO in addition to CO₂ and H₂. CO in the reformate typically is reduced via the water gas-shift (WGS) reaction. However, the exit gas from the low temperature shift (LTS) reactor following the high temperature shift (HTS) stage still contains roughly 5,000-10,000 ppm (0.5-1%) of CO, which cannot be tolerated by PEM fuel cells. Thus, preferential oxidation (PrOx) reactors are used following the shift reactors to reduce CO to tolerable levels. The preferential oxidation (PrOx) reactor oxidizes CO to CO₂ typically over a metal, e.g., Pt, based catalyst by bleeding small amounts of air or oxygen at an elevated temperature, typically above 100° C. Due to the limited selectivity, however, an excess of O₂ typically is required to reduce CO to low levels in the PrOx system, which burns the hydrogen present in the reformate, thus reducing the overall efficiency.

Key parameters for the preferential oxidation (PrOx) system are complex control of O₂ and temperature and the high activity and selectivity of the catalyst in order to minimize the CO content in the effluent while keeping H₂ consumption at a low level. Typically used catalysts for PrOx include Pt/Al₂O₃, Ru/Al₂O₃, Rh/Al₂O₃, Au/MnOₓ, Pt—Ru/Al₂O₃ and Ir-based catalyst, such as 5% Ir/CoOₓ—Al₂O₃/carbon. The selectivity toward the preferential oxidation of CO in the PrOx system also depends upon temperature. Therefore, the CO selective oxidation reactor requires very careful cooling and temperature control, which is a major technical challenge. For example, a two stage reactor with three heat exchangers to carefully control the temperatures of the process stream upstream, in between, and downstream the reactor is described in U.S. Pat. No. 5,271,916. Both of the O₂ streams to the reactors are predetermined and carefully controlled.

Thus, despite the fact that the PrOx technology is now universally adopted in fuel reformers, the process is, in fact, cumbersome, involving two or more stages with inter-cooling and distributed air or water injection. The PrOx stage is bulky, being roughly 10-15% of the total size of the reformer plant. There is also a relatively long reactor warm-up period and large transient CO concentration during reactor start up.

Therefore, there is a need for developing improved methods for purifying a gas effectively, for example, removing CO from a reformate gas.

### SUMMARY OF THE INVENTION

The present invention is directed to an electrochemical device and a method of purifying a gas by use of the electrochemical device.

In one embodiment of the invention, the electrochemical device comprises a first electrochemical reactor and a gas source.

The first electrochemical reactor includes a single or multiple electrochemical cells; a first gas inlet and outlet; a second gas inlet and outlet; a galvanostat. Each of the electrochemical cells includes a first gas inlet, an anode and a first gas outlet; a cathode compartment that includes a second gas inlet, a cathode and a second gas outlet; and an ion-selective partition between the anode and cathode. The first gas inlet and outlet of the electrochemical reactor is in fluid communication with the anode compartment of each of the cells. The second gas inlet and outlet of the electrochemical reactor is in fluid communication with the cathode compartment of each of the cells. The galvanostat of the electrochemical reactor is in electrical communication with the anode and cathode. The gas source is in fluid communication with the anode compartment or cathode compartment of each of the electrochemical cells, including at least two components that are selectively reactive relative to each other. The selectivity of the two components of the gas source is dependent upon an electrical potential between the anode and cathode, whereby a constant current between the anode and cathode causes the electrical potential to oscillate autonomously while the gas components are directed through the anode compartment or cathode compartment. The oscillation in potential causes autonomous oscillation of selective reaction of the gas components.

In a preferred embodiment, the first or second gas outlet of the electrochemical device is in fluid communication with another device, for example, a fuel cell system that includes a single fuel cell or a stack of fuel cells.

Each of the fuel cells includes an anode compartment, a cathode compartment and a proton-exchange membrane between the anode and cathode compartments, wherein the first or second gas outlet of the electrochemical device is in fluid communication with the anode or cathode compartment of the fuel cell system.

Preferably, the gas source is in fluid communication with the anode compartment of each of the electrochemical cells. Preferably, in this case, the first gas outlet of the electrochemical device is in fluid communication with the anode compartment of the fuel cell system.

In another embodiment, the invention is directed to a method for purifying a gas. The method comprises the step of directing the gas from a gas source through an anode compartment or cathode compartment of an electrochemical reactor.

The electrochemical reactor further includes an ion-selective partition between the anode compartment and cathode compartment and a galvanostat in electrical communication with an anode of the anode compartment and a cathode of the cathode compartment. The gas to be purified includes at least two components that are selectively reactive relative to each other. The selectivity of the two components is dependent upon an electrical potential between the anode and cathode, whereby a constant current between the anode and cathode causes the electrical potential to oscillate autonomously while the gas is directed through the anode compartment or cathode compartment. The oscillation in potential causes autonomous oscillation of selective reaction of the gas components that predominantly removes one of the two components, thereby purifying the gas.

Preferably, the gas to be purified is directed through the anode compartment of the electrochemical reactor.

In another embodiment, the method further includes the step of directing the purified gas through an anode compartment or a cathode compartment, of a fuel cell system that includes a single fuel cell or a stack of fuel cells. Preferably, the gas to be purified is directed through the anode compartment of the electrochemical reactor. Preferably, in this case, the purified is then directed to the anode compartment of the fuel cell system.

The electrochemical device of the invention that utilizes selective reaction of at least two gas components relative to each other can be used for purifying a gas containing at least two components. Because, in the present invention, an essentially constant current between the anode and cathode causes the electrical potential to oscillate autonomously, whereby the oscillation in potential causes autonomous oscillation of selective reaction of the gas components, removal of one of the two components is autonomously controlled. For example, the electrochemical reactor of the invention can be used for removing CO from the hydrogen-rich reformate by electrochemical preferential oxidation of CO (ECPrOx). As shown in Example 1, CO was efficiently removed from a hydrogen gas containing 100-1000 ppm of CO by an autonomously controlled, selective CO oxidation without resorting to an external power source at a low temperature of between about 25° C. and about 30° C.

The present invention in the ECPrOx system has several advantages over conventional PrOx systems. As discussed above, PrOx systems typically are bulky and cumbersome, involving two or more stages with inter-cooling and distributed air or water injection. PrOx systems also require a relatively long reactor warm-up period and large transient CO concentration during reactor start up. Careful oxygen or air injection control is necessary in the PrOx system to prevent over-consumption of hydrogen.

In contrast, the ECPrOx system is compact, not requiring inter-cooling, water injection or careful oxygen or air control. Also, because the ECPrOx system can be performed at relatively low temperatures, such as near room temperature, it is comparable to fast cold-starting, and does not require warming-up of the reactor. The invention additionally is advantageous in that the necessary electrical potential for the CO oxidation is produced in situ by the potential difference established by O₂ reduction, CO oxidation and H₂ oxidation reactions, i.e., an anode potential oscillation at an essentially constant current density. Thus, CO oxidation can be achieved without resorting to an external power supply in the ECPrOx system. Outlet CO concentration is thus maintained at a suitable level because the potential oscillates autonomously in an effort to maintain the desired current. Also, the ECPrOx system generates supplemental power, which can be integrated into a fuel cell power plant.

### BRIEF DESCRIPTION OF THE DRAWINGS

FIGS. 1(a)-(b) are a schematic representation of an electrochemical device of the invention.

FIG. 2(a) is a schematic representation of another embodiment of the invention, wherein the electrochemical device of FIGS. 1(a)-(b) is combined with a rechargeable battery.

FIG. 2(b) is a schematic representation of another embodiment of the invention, wherein the fuel cell system is a PEM fuel cell system.

FIG. 3 is a graph showing a cell voltage pattern at room temperature for anode feed change from H₂/200 ppm CO to H₂/1000 ppm CO by use of an embodiment of the invention.

FIG. 4 is a graph showing an anode outlet CO concentration at different inlet flow rates by use of an embodiment of the invention.

FIGS. 5(a)-5(b) are graphs showing an anode outlet CO concentration as a function of inlet flow rates at various current densities in an electrochemical device of the invention.

FIG. 6(a) is a graph showing comparison of power outputs at stationary and oscillatory states in an electrochemical device of the invention.

FIG. 6(b) is a graph showing the effect of anode inlet flow rate on the time-averaged power density in an electrochemical device of the invention.

FIG. 7 is a graph showing the effect of temperature on the outlet CO concentration in an electrochemical device of the invention.

FIGS. 8(a)-(b) are graphs showing the effect of total pressures on the anode outlet CO concentration in an electrochemical device of the invention.

FIG. 9 is a graph showing the effect of total pressures on the outlet CO concentration in an electrochemical device of the invention.

FIGS. 10(a)-(b) are graphs showing the effect of PtRu catalyst loading on the outlet CO concentration in an electrochemical device of the invention.

FIG. 11 is a graph showing the effect of humidification on the outlet CO concentration in an electrochemical device of the invention.

FIG. 12(a) is a graph showing CO conversion as a function of inlet flow rates at two current densities in an electrochemical device of the invention.

FIG. 12(b) is a graph showing fraction of CO electrooxidation current as a function of inlet flow rates at two current densities in an electrochemical device of the invention.

FIG. 12(c) is a graph showing hydrogen recovery as a function of inlet flow rates at two current densities in an electrochemical device of the invention.

FIG. 13(a) is a graph showing CO conversion at different CO concentrations in an electrochemical device of the invention.

FIG. 13(b) is a graph showing fraction of CO electrooxidation current at different CO feed concentrations in an electrochemical device of the invention.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

One embodiment of the present invention is directed to an electrochemical device that includes a fuel cell system; a first electrochemical reactor having a galvanostat; and a single or multiple electrochemical cells; and a gas source in fluid communication with the anode compartment or cathode compartment of each of the electrochemical cell, including at least two components that are selectively reactive relative to each other, where the selectivity of the two components of the gas source is dependent upon an electrical potential between the anode and cathode, whereby a constant current between the anode and cathode causes the electrical potential to oscillate autonomously while the gas components are directed through the anode compartment or cathode compartment. The oscillation in potential causes autonomous oscillation of selective reaction of the gas components. The first or second gas outlet of the electrochemical device is in fluid communication with the anode or cathode compartment of the fuel cell system.

The gas source is preferably in fluid communication with the anode compartment of each of the electrochemical cells. Preferably, in this case, the first gas outlet of the electrochemical device is in fluid communication with the anode compartment of the fuel cell system.

Preferably, the gas source includes carbon monoxide.

The fuel cell system can include a single fuel cell or a stack of fuel cells. Examples of the fuel cells include a proton-exchange membrane (PEM) fuel cell, a phosphoric acid fuel cell, a solid oxide fuel cell, an alkaline fuel cell and a molten carbonate fuel cell. Preferably, the fuel cells are a proton-exchange membrane (PEM) fuel cell.

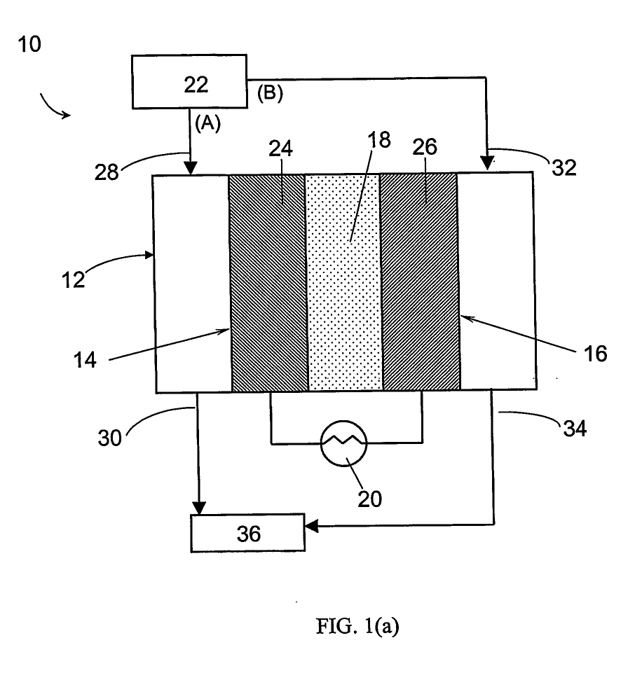

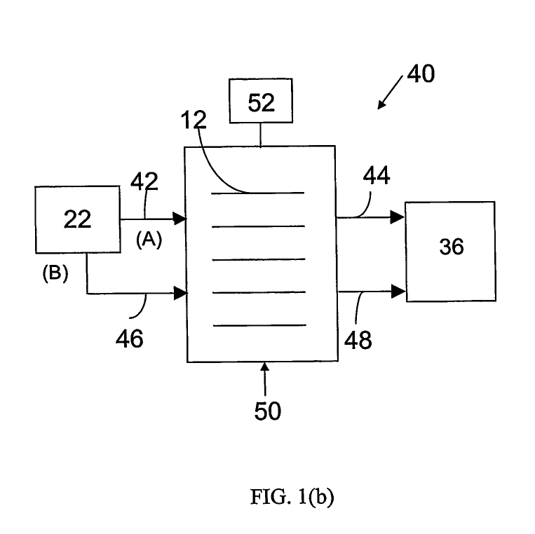

In one embodiment of the invention, as shown in FIG. 1 (a), electrochemical device 10 comprises a first electrochemical reactor that includes a single electrochemical cell 12, including anode compartment 14, cathode compartment 16 and ion-selective partition 18; galvanostat 20; gas source 22; and fuel cell system 36. Anode compartment 14 includes first gas inlet 28, anode 24 and first gas outlet 30. Cathode compartment 16 includes second gas inlet 32, cathode 26 and second gas outlet 34. First or second gas outlet 30 or 34 is in fluid communication with fuel cell system 36.

In another embodiment of the invention, as shown in FIG. 1(b), electrochemical device 40 comprises a first electrochemical reactor that includes electrochemical cell stack 50, including multiple electrochemical cells 12; first gas inlet 42 and first gas outlet 44, which are in fluid communication with the anode compartment of each of the electrochemical cells 12; second gas inlet 46 and second gas outlet 48, which are in fluid communication with the cathode compartment of each of the electrochemical cells 12; galvanostat 52 in electrical communication with the anode and cathode of each of the electrochemical cells; gas source 22; and a fuel cell system 36. The first gas inlet and outlet of each of electrochemical cells 12 (not shown) are in fluid communication with first gas inlet 42 and outlet 44 of the first electrochemical reactor, respectively. The second gas inlet and outlet of each of electrochemical cells 12 (not shown) are in fluid communication with second gas inlet 46 and outlet 48 of the electrochemical reactor, respectively. First or second gas outlet 44 or 48 is in fluid communication with fuel cell system 36.

Gas source 22 is in fluid communication with the anode compartment of each of the electrochemical cells, as shown in (A) of FIGS. 1(a)-1(b) or with the cathode compartment of each of the electrochemical cells, as shown in (B) of FIGS. 1(a)-(b), preferably, with the anode compartment. Preferably, when the gas source is in fluid communication with the anode compartment, first gas outlet 30 in FIG. 1(a) or first gas outlet 44 in FIG. 1(b) is in fluid communication with fuel cell system 36. In this case, preferably, the gas source includes carbon monoxide. The concentration of CO in the gas source is, for example, at least 50 ppm, particularly, in a range of between 50 ppm and about 20,000 ppm. Preferably, the gas source is a CO-containing, hydrogen-rich reformate source.

Examples of fuel cell system 36 are as described above, preferably, fuel cell system 36 includes a single PEM fuel cell or a stack of PEM fuel cells.

Ion-selective partition 18 is located between the anode compartment 14 and cathode compartment 16, and has a high permeability to an ion, such as proton, hydroxide and carbonate, preferably proton. Examples of the ion-selective partition 18 include a cation-exchange membrane such as a proton-exchange membrane, a KOH-solution, phosphoric acid, molten carbonate and ZrO₂-ceramics. Preferably, the proton-selective partition is a proton-exchange membrane. More preferably, the proton-exchange membrane includes a solid polymer. Examples of the solid polymer include ionomers based on ethylenes, styrenes, rubbers or poly(tetrafluoroethylene) (e.g. Teflon®, E. I. du Pont de Nemours and Co.), sulfonated polyether ether ketones and polybenzimidazoles. Preferably, the proton-exchange membrane includes a perfluorinated ionomer. Preferably, the perfluorinated ionomer includes an ionomer based on poly(tetrafluoroethylene), such as a perfluorinated ionomer that contains sulfonic or carboxylic groups, reinforced with Teflon® (e.g. Naflon®, E. I. du Pont de Nemours and Co.)

The anode and cathode of electrochemical cell 12 are each preferably a gas diffusion electrode that permits the flow of gaseous reactants and products. The gas diffusion electrodes conventionally are made of an electrode support, a metal catalyst layer and a binder that join the electrode support and metal catalyst layer.

The electrode support typically is made from porous carbon paper or carbon cloth. The metal catalyst layer includes a metal catalyst that is typically dispersed in carbon black. Examples of the metal catalyst include Pt, Ru, Pd, Rh, Ir, Fe, Co, Cr, Cu, Ag, Ni, Mo and Au. Preferably, the metal catalyst for the anode includes at least one element selected from the group consisting of Pt, Ru, Pd, Rh, Ir, Fe, Co, Cu, Ag, Ni, Mo and Au. The metal catalyst for the cathode preferably includes at least one element selected from the group consisting of Pt, Co, Cr and Ni. The amount of loading of each of the metal catalysts for the anode and cathode can be balanced according to different requirements of anode and cathode reactions. For example, lower amount of metal catalyst, e.g., Pt or PtRu, can be used in the cathode than in the anode. The metal catalysts can further include Al₂O₃, an oxide of manganese, an oxide of cobalt, an oxide of nickel, AgO or a mixture thereof.

The binder preferably is a polymer that can ensure the mechanical strength of the electrode, and have high gas permeability. Examples of the polymer include copolymers of fluoropolymers and sulfonated polyarylene sulfones, sulfonated polyether ether ketones and polyimides; poly(tetrafluoroethylene) (e.g. Teflon®, E. I. du Pont de Nemours and Co.); and a perfluorinated ionomer, such as a perfluorinated ionomer, reinforced with poly(tetrafluoroethylene). Herein the term “ionomer” refers to an ion-containing polymer.

The electrode and ion-selective partition can be assembled as a whole, such as a membrane-electrode assembly (MEA). Typically, an ionomer such as a perfluorinated ionomer (e.g., Nafion®) is used as a binder and ion-selective partition.

Galvanostat 20 in FIG. 1(a) or galvanostat 52 in FIG. 1(b) is set at an essentially constant current density between the anode and cathode, for example, at a value in a range of between about 30 mA/cm² and about 700 mA/cm². A DC electronic load such as HP 6060B DC electronic load (Hewlett Packard/Agilent) or a conventional galvanostat/potentiostat can be used to maintain the current density between the anode and cathode essentially constant.

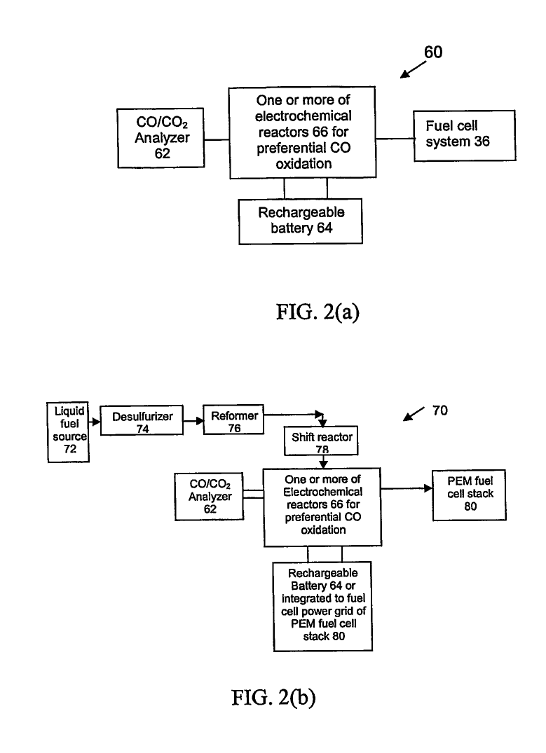

In a preferred embodiment, gas source 22 contains CO, preferably a CO-containing, hydrogen-rich reformate. In this embodiment, as shown in FIG. 2(a), electrochemical device 60 includes CO and/or CO₂ gas analyzer 62 in fluid communication with the first gas outlet of electrochemical reactors 66 of the invention, as discussed above. More than one electrochemical reactor can be used in a parallel way. Optionally, electrochemical device 60 further includes rechargeable battery 64 connected to electrochemical reactors 66, whereby power output of the reactor is stored in the battery.

In a more preferred embodiment, the electrochemical device of the invention for preferential oxidation of CO can be integrated into a PEM fuel cell system. The PEM fuel cell system can include a single PEM fuel cell or a stack of PEM fuel cells. As shown in FIG. 2(b), electrochemical device 70 includes one or more electrochemical reactors 66, as shown in FIGS. 1(a)-(b), for preferential oxidation of CO and further includes PEM fuel cell stack 80 that comprises an anode compartment, a cathode compartment and a proton-exchange membrane between the anode and cathode compartments (not shown). The first gas outlet of electrochemical reactors 66 is in fluid communication with the anode compartments of the fuel cells. In this embodiment, a liquid fuel, such as gasoline or alcohols, from liquid fuel source 72 goes through desulfurizer 74, and hydrogen-rich reformate is produced by reformer 76. CO contained in the reformate is removed by shift reactor 78 and then subsequently by electrochemical reactors 66. Alternatively, CO contained in the reformate can be removed directly by electrochemical reactors 66 without shift reactor 78. The CO-depleted, hydrogen-rich reformate is then used as a fuel source of PEM fuel cell stack 80. Power output of the electrochemical reactor can be stored in rechargeable battery 64 or integrated into the power output of PEM fuel cell stack 80.

In another embodiment of the invention, the electrochemical device further includes a second electrochemical reactor. The elements of the second electrochemical reactor are as described above for the first electrochemical reactor. In this embodiment, the first gas outlet of the first electrochemical reactor is in fluid communication with the first gas inlet of the second electrochemical reactor, and the first gas outlet of the second electrochemical reactor is in fluid communication with the anode or cathode compartment, preferably anode compartment of the fuel cell system. As with the first electrochemical reactor, the second electrochemical reactor can include a single or multiple electrochemical cells. Examples of the fuel cell are as described above. In a preferred embodiment, the fuel system is a PEM fuel cell system.

The materials for the anode, cathode and ion-selective partition of the second electrochemical reactor can be the same as or alternatively, can be different from those of the first electrochemical reactor.

Each of the galvanostats of the first and second reactor can be set at the same value or alternatively can be set a different value from each other. Examples of the values of the galvanostats are as described above.

In a preferred embodiment, the gas source of the device contains CO, preferably a CO-containing, hydrogen-rich reformate. In this embodiment, the first and second electrochemical reactors are used for preferential oxidation of CO (ECPrOx), and further includes a CO and/or CO₂ gas analyzer in fluid communication with the first gas outlet of the second electrochemical reactor or CO and/or CO₂ gas analyzers in fluid communication with each of the first outlets of the first and second electrochemical reactors. Optionally, the electrochemical device of this embodiment further includes a rechargeable battery connected to both the first and second reactors, whereby power output of the reactors is stored in the battery.

In the electrochemical device that further includes the second electrochemical reactor, the fuel cell system is a PEM fuel cell system, and optionally, the power output of the electrochemical device can be integrated into the power output of the PEM fuel cell system.

The electrochemical device of the invention can include multiple electrochemical reactors in which each of the electrochemical reactors is connected in a parallel way, as described above for the electrochemical device that includes two electrochemical reactors. Materials and features of each of the electrochemical reactors are as described above.

The present invention further includes a method of purifying a gas by the use of the electrochemical device of the invention.

In a preferred embodiment, the method utilizes the electrochemical device, as described above, for example, electrochemical device 10, 40, 60 or 70 of FIGS. 1-2. The method comprises the step of directing the gas to be purified from gas source 22 through anode compartment 14 or cathode compartment 16, preferably, through anode compartment 14; and directing the purified gas through the anode or cathode compartment of the fuel cell system.

Preferably, the purified gas is directed through the anode compartment of the fuel cell system. Examples of the fuel cell are as described above.

In a more preferred embodiment, the gas from gas source 22 comprises CO, such as a CO-containing, hydrogen-rich reformate. Even more preferably, the method removes CO selectively from the reformate. For example, in a system as shown in FIG. 2(b), the CO-containing, hydrogen-rich reformate from shift reactor 78 or directly from reformer 76 can be purified by the method of the invention using the electrochemical device as described above.

In particular, when the gas to be purified includes a CO-containing, hydrogen-rich reformate, where CO is selectively removed from the reformate, the fuel cell is preferably a PEM fuel cell system that includes a single PEM fuel cell or a stack of PEM fuel cells.

Typically, a temperature that is used for the method of purifying the CO-containing, hydrogen-rich reformate, as described above, depends upon the materials for the anode and cathode. Preferably, the method of purifying the CO-containing, hydrogen-rich reformate is performed at a temperature in a range of between about 10° C. and about 80° C., preferably, between about 20° C. and about 35° C. When the CO-containing, hydrogen-rich reformate is directed through anode compartment 14 at a temperature described above, galvanostat 20 is preferably set at a value in a range of between about 30 mA/cm² and about 700 mA/cm², preferably, between about 100 mA/cm² and about 700 mA/cm². The value of the galvanostat, i.e., current density between anode 24 and cathode 26, can be adjusted accordingly to obtain a desired CO oxidation rate.

One embodiment of the invention is also directed to a method of purifying a gas that includes CO and hydrogen. The method comprises the step of directing the gas from a gas source through an anode compartment of an electrochemical reactor. The electrochemical reactor further includes an ion-selective partition between the anode compartment and cathode compartment; and a galvanostat in electrical communication with an anode of the anode compartment and a cathode of the cathode compartment. Selectivity of reaction of CO and hydrogen at the anode compartment is dependent upon an electrical potential between the anode and cathode, whereby a constant current between the anode and cathode causes the electrical potential to oscillate autonomously while the gas is directed through the anode compartment, the oscillation in potential causing autonomous oscillation of selective reaction of CO and hydrogen that predominantly removes CO, thereby purifying the gas. Features and materials for the electrochemical reactor are as described above. This method of the invention can be used for removing CO of a gas source for, for example, a fuel cell system.

The following examples are intended to be representation of the invention and not limiting in any other way.

### EXEMPLIFICATION

### Example 1

### Construction of the Electrochemical Preferential Oxidation (ECPrOx) System

A gas diffusion electrode loaded with 20% (w/o) Pt/C at a metal loading of 0.4 mg/cm² acquired from E-TEK was used as cathode. A gas diffusion electrode loaded with 20% (w/o) PtRu/C with 0.35 mg/cm² metal loading, or 40% (w/o) PtRu/C with 0.7 mg/cm² metal loading were used as the anode. The electrodes were hot-pressed onto a Nafion® 117 proton-exchange membrane to form a membrane-electrode assembly (MEA) at 130° C. and under a load of 4000 lbs of force for about 2 minutes.

The MEA was then incorporated into a 5 cm² single cell from ElectroChem, Inc. (Woburn, Mass.), and tested in a test station with temperature, pressure, humidity and flow rate control. The graphite bipolar plate had serpentine flow channels. The ECPrOx unit was operated at room temperature unless otherwise noted. The room temperature recorded in the laboratory varied between 25 and 30° C. The anode and cathode gases were humidified in stainless steel bottles containing water at room temperature before introduction into the unit. The total pressure of both anode and cathode sides was maintained at 30 psig except in the experiments on the effect of pressure. The volumetric flow rates were all at the standard state (1 atm and 25° C.) in units of standard cubic centimeters per min (sccm).

The current-voltage characteristics were recorded using a HP 6060B DC electronic load, interfaced with a PC using LabVIEW software (National Instruments, Austin, Tex.), with a data sampling rate of 0.226 s. The anode exit gas stream was monitored by a Model 200 IR CO/CO₂ gas analyzer (California Analytical Instruments, Orange, Calif.). The FP-AI-100 analog input module/FP-1000 network module (National Instruments, Austin, Tex.) was used to collect data from the gas analyzer using LabVIEW. Simulated reformate (from premixed gas cylinder) was introduced to the anode at a flow rate controlled by a mass flow controller. A variety of feeds were tested: H₂/100 ppm CO, H₂/200 ppm CO (MG Industries, Morrisville, Pa.); H₂/1000 ppm CO (Spec Air, Auburn, Me.); and H₂/24.1% CO₂/9380 ppm CO (AGA Gas, Maumee, Ohio). These premixed gases were used as an anode feed, while oxygen was fed to the cathode.

Concept of ECPrOx System

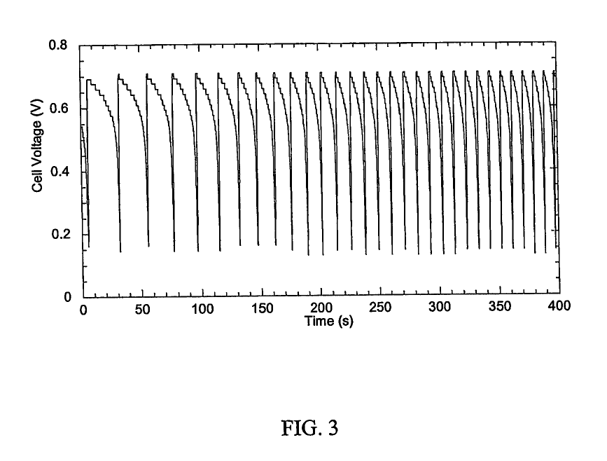

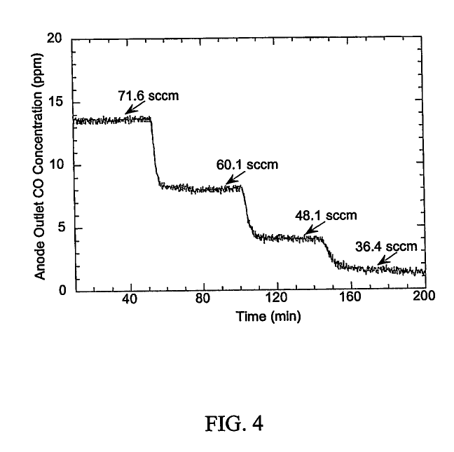

The ECPrOx system of the invention was based on a potential oscillation that adjusted automatically at a constant current density according to the CO concentration in the feed stream. The voltage pattern when the anode feed was switched from H₂/200 ppm CO to H₂/1000 ppm CO is shown in FIG. 3. With the introduction of higher concentration of CO in the anode feed, the oscillation period decreased, i.e., the oscillation became faster. Such potential oscillations indicated that a significant amount of CO entering the anode was electrooxidized on the catalyst surface. A typical result of the anode outlet CO concentration with the step change in anode inlet flow rate is shown in FIG. 4. The anode feed was H₂ containing 200 ppm of CO. The cell was operated at room temperature and a current density of 200 mA/cm². The exit CO concentration was very stable over time for different inlet flow rates. The CO concentration could be brought down to about 13 ppm at an inlet feed rate of 71.6 sccm, and below 2 ppm at 36.4 sccm for a feed containing 200 ppm CO. It is thus evident that the CO concentration in hydrogen can be reduced without resorting to an external power supply.

The ECPrOx unit had the same function of the conventional PrOx reactor. A current control device was used to control the hydrogen consumption rate and the CO conversion. A CO sensor can be put in series with the ECPrOx exit stream to monitor the CO concentration, and possibly for control. The supplemental power produced by the ECPrOx unit can be stored in a rechargeable battery or integrated directly to the fuel cell power plant. The ECPrOx unit can be built in the same modular structure as PEM fuel cells. In cases such as methanol steam reformation where the exit CO concentration from the reformer is low, then it can replace the shift reactor with the ECPrOx unit.

Performance of ECPrOx at Different Feed CO Concentrations

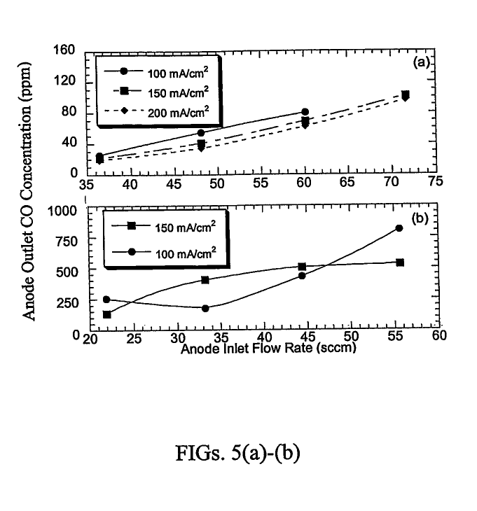

The outlet CO concentration as a function of inlet flow rate is plotted in FIG. 5(a) at various current densities for an anode feed containing 1000 ppm CO. As shown in FIG. 5(a), the outlet CO concentration increased with the inlet flow rates at a given current density. The outlet CO concentration decreased with increase of the current density at a given inlet flow rate. However, the decrease of the outlet CO concentration at a given inlet flow rate became small as the current density increased.

Since two-stage ECPrOx may be required, experiments were conducted using feed CO concentrations ranging from 100 to 10,000 ppm. Thus a feed gas of H₂/24.1% CO₂/0.938% CO was used to simulate the reformate gas stream from the LTS reactor. The exit CO concentration for this feed as a function of inlet flow rate is plotted in FIG. 5(b), for an anode catalyst loading of 0.7 mg/cm² PtRu. As can be seen in FIG. 5(b), the CO concentration was lowered from 9380 ppm to about 140 ppm for an inlet flow rate of 21.9 sccm, and about 500 ppm at a flow rate of 55.6 sccm and a current density of 150 mA/cm². The trends observed were different from that for lower CO concentrations as in FIG. 5(a). This difference was due to transition of cell voltage between stationary and oscillatory states. The current density and flow rates were two parameters that affected the onset of potential oscillations. The oscillation born at relatively smaller flow rates was suppressed when the flow rates were increased. For example, at a current density of 100 mA/cm², oscillation disappeared when the inlet flow rates exceeded 33.2 sccm, while at a current density of 150 mA/cm², the oscillation disappeared when the inlet flows was greater than 55.6 sccm. Due to the transition from an oscillatory state to a stationary one, the monotonous change in exit CO concentration with flow rates was not observed for a current density of 100 mA/cm², as shown in FIG. 5(b). The lower exit CO concentration at the stationary state was due to the fact that the cell voltage at stationary states was much lower than the time-averaged cell voltage at oscillatory states (i.e., the anode overpotential was higher at a stationary state than the time-averaged anode overpotential at oscillatory state). The higher anode overpotential lead to a higher CO electrooxidation rate. However, for the same state of cell operation (either oscillatory or stationary), the exit CO concentration always increased with the inlet flow rates.

Due to the high concentration of CO₂ (24.1%) in the feed, there was a distinct possibility that the reverse water gas shift reaction proceeded at the anode catalyst. However, reverse water gas shift reaction is not favored at low temperatures, either kinetically and thermodynamically.

Supplemental Electrical Power

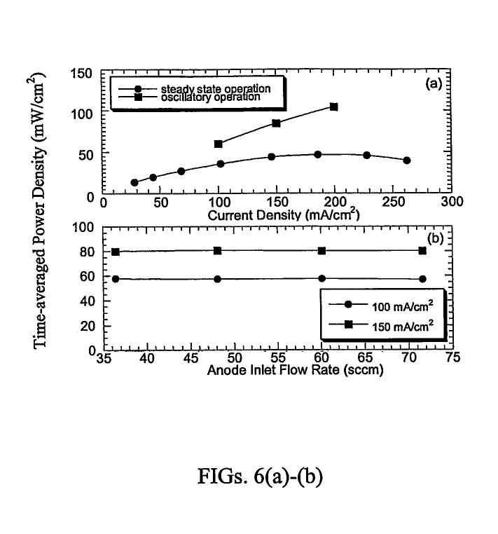

As has been mentioned in the previous section, no external electrical power source is needed for the ECPrOx. On the contrary, supplemental electrical power is generated. An enhanced power output was observed for higher CO concentration (e.g., 200 ppm and 1000 ppm CO) in the ECPrOx operation. A comparison of the supplemental power output under stationary and oscillatory states at the same experimental conditions is shown in FIGS. 6(a)-(b). As seen in FIG. 6(a), the maximum power density under steady state operation was about 47 mW/cm² at a current density of around 200 mA/cm². However, the power output under the oscillatory state was over 100 mW/cm², and had not yet peaked. Even when the anode feed contained 1000 ppm CO (FIG. 6(b)), the power output under the oscillatory state did not fall appreciably even though the CO concentration in the feed increased 5 fold. Further, the power output at the oscillatory state did not change appreciably with inlet feed rates.

Thus, the ECPrOx process effectively removed CO from reformate gas to produce clean hydrogen on the one hand, while also generating supplemental electrical power, which (at oscillatory state) was even higher than that at a stationary state at otherwise identical conditions. Such a characteristic of ECPrOx would increase the overall energy efficiency of the reformer/fuel cell system.

Effect of Operating Temperature

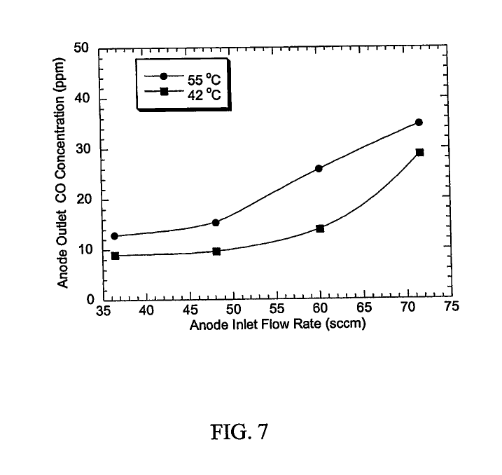

FIG. 7 shows the exit CO concentration at two different temperatures. In this experiment, the anode feed was hydrogen containing 100 ppm CO. The exit CO concentration increased with the cell temperature, exceeding 30 ppm for an inlet flow rate of 71.6 sccm at 55° C. This indicates that low temperature operation is preferable for ECPrOx to remove CO from the hydrogen rich gas stream.

Similar results were obtained for the feed containing 9380 ppm CO. At a current density of 140 mA/cm² and a flow rate of 44.4 sccm (catalyst loading 0.35 mg/cm²), the exit CO concentration was 638 ppm at 35° C., while the exit CO concentration was above 1000 ppm (over the detection range of the gas analyzer) when the unit is operated at 80° C.

The kinetic and mechanistic study by Schubert et al. (M. M. Schubert, M. J. Kahlich, H. A. Gasteiger, and R. J. Behm, J. Power Sources, 84, 175 (1999), the entire teachings of which are incorporated herein by reference) showed that the selectivity of conventional CO preferential oxidation is determined by the steady-state surface coverage. Thus, there is a loss in selectivity with decreasing surface coverage of CO as CO partial pressure decreases. Similarly for ECPrOx, the CO surface coverage decreases due to the reduced CO adsorption equilibrium constant at elevated temperatures. The adsorption of CO on noble metal catalyst surface is an exothermic process, the enthalpy change being about −115 kJ/mol on Ru, and around −130 kJ/mol on Pt. The heat of adsorption decreases with an increase of surface coverage of CO, but is still about −45 kJ/mol at near saturation coverage.

Effect of Operating Pressure

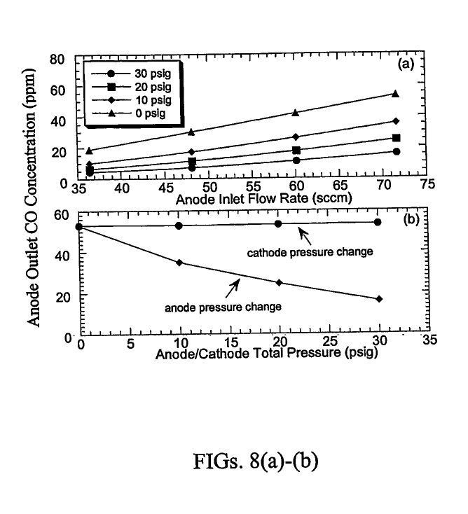

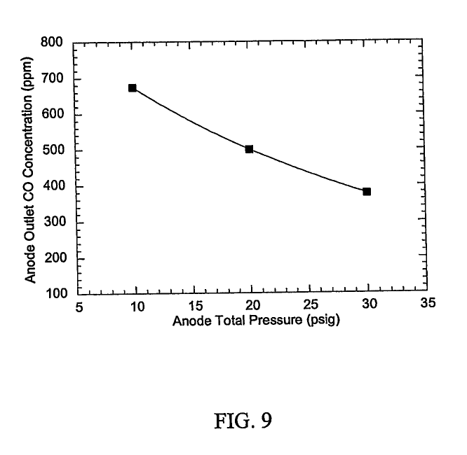

In order to study the influence of operating pressure on the exit CO concentration from ECPrOx, the total pressure of both the anode and the cathode were lowered from 30 psig to 0 psig in a stepwise manner while the other experimental conditions remained fixed. The corresponding exit CO concentration as a function of inlet flow rate is shown in FIG. 8(a), for a feed containing 200 ppm CO with the unit operated at 100 mA/cm². With the decrease of the operating pressure, there was a significant increase in the exit CO concentration. At a feed rate of 60.1 sccm, the CO concentration jumped from 10 ppm at 30 psig to 42 ppm at 0 psig. The increase in exit CO concentration became more significant as the total pressure approached atmospheric pressure. Further, experiments were conducted to single out the effect of pressure change in the individual anode and cathode compartments (FIG. 8(b)). In one experiment, at an inlet flow rate of 71.6 sccm, the anode pressure was fixed at 0 psig while the cathode pressure was increased stepwise from 0 psig to 30 psig. The anode exit CO concentration remained unchanged (FIG. 8(b)). In another experiment, the cathode oxygen total pressure was fixed at 30 psig while the anode total pressure was increased stepwise from 0 psig to 30 psig. The exit CO concentration dropped in exactly the same manner as observed in FIG. 8(a). Therefore, it is evident that it is the anode pressure that is responsible for the change in exit CO concentration with varying operating pressures. The same result was observed for a feed containing 9380 ppm CO. As seen in FIG. 9, at a current density of 100 mA/cm² and feed rate of 44.4 sccm, the exit CO concentration decreased with increase of the anode pressure. The exit CO concentration dropped from about 680 ppm at 10 psig to about 380 ppm at 30 psig.

A high anode total pressure (i.e., high CO partial pressure) is, thus, beneficial, to the removal of CO from the gas stream. A high CO partial pressure leads to an increase in the CO adsorption rate, and a high CO surface coverage. Therefore, the CO electrooxidation rate increases. This observation indicates that the ECPrOx can be operated at low pressures, or with air at ambient pressure.

Effect of Catalyst Loading

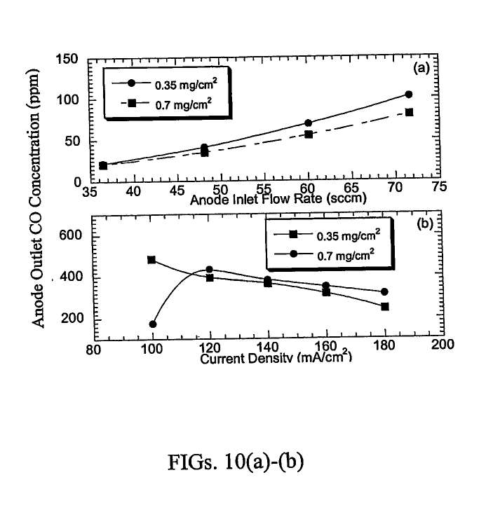

The effect of catalyst loading is shown in FIGS. 10(a)-(b). A higher catalyst loading was beneficial in lowering the exit CO concentration. The improvement became more apparent at higher flow rates and at higher inlet CO concentrations. At a flow rate of 71.6 sccm, the difference in exit CO concentration was about 5 ppm for feed containing 200 ppm CO, while for a feed containing 1000 ppm CO, the difference was around 25 ppm, as shown in FIG. 10(a).

The effect of catalyst loading for a feed containing 9380 ppm CO is shown in FIG. 10(b). In FIG. 10(b), the exit CO concentrations are compared at a given inlet flow rate but at different current densities. At a given inlet flow rate, the exit CO concentration decreased monotonously with an increase of operating current density for catalyst loading of 0.35 mg/cm², in which case cell voltage remained at a stationary state. However, the CO concentration experienced a large jump between a current density of 100 and 120 mA/cm² for the case of catalyst loading of 0.7 mg/cm². This sudden concentration change was due to the transition of the cell voltage from a stationary state to an oscillatory state as a result of increased current density. At the upper branch (cell voltage in oscillatory state), the CO concentration also decreased with increasing current density, and was slightly higher than that at the lower catalyst loadings at a given current density. However, the above result does not necessarily lead to the conclusion that low catalyst loading was beneficial to feed containing high CO concentrations due to the following reasons. Firstly, the ECPrOx unit was preferably operated at low current density, e.g., 100 mA/cm², where the exit CO concentration for the lower catalyst loading was more than double as compared to that for the higher loading. Secondly, although the exit CO concentration at higher current densities was slightly lower for the low-loading unit, the cell voltage for the low-loading unit was polarized to almost zero. Reduction in exit CO concentration was only a part of the benefit of a higher catalyst loading. Supplemental power output increased as well at higher catalyst loadings in the anode. For example, at a current density of 150 mA/cm² and a feed containing 1000 ppm CO, the average power output was 43.5 mW/cm² for a catalyst loading of 0.35 mg/cm², while it was about 80 mW/cm² for an anode loading of 0.7 mg/cm².

Effect of Humidification

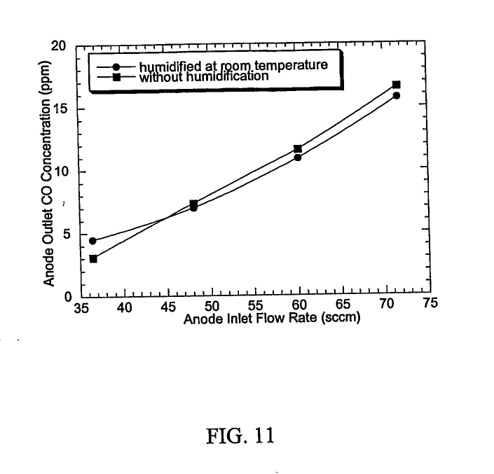

The exit CO concentration was also compared with and without humidification of the feed gases at otherwise identical experimental conditions. The anode and cathode feed were introduced directly into the ECPrOx Unit, with the humidifier bypassed, for an anode feed containing 200 ppm of CO. As seen in FIG. 11, the exit CO concentration was virtually identical. In the case of humidification (at room temperature), the water partial pressure was relatively small (0.032 atm, assuming a 100% relative humidity). Thus, for this case, water produced by the electrochemical reaction at the cathode was more significant in terms of contribution to the hydration of the membrane. For Nafion 115 membrane, the membrane conductivity does not change appreciably with current density up to about 1000 mA/cm² (see, for example, S. Slade, S. A. Campbell, T. R. Ralph, and F. C. Walsh, J. Electrochem. Soc., 149, A1556 (2002), the entire teachings of which are incorporated herein by reference), which is well above the current densities in this work (100-200 mA/cm²). Therefore, water transport due to electro-osmotic drag can be counterbalanced by the back-diffusion of liquid water produced at the cathode membrane-electrode interface. Thus, although Nafion 117 membrane was used, there may not be membrane dehydration even without feed humidification due to low temperature and current densities used.

Characterization of ECPrOx Unit

In order to characterize and compare the performance of ECPrOx unit with the conventional PrOx reactor, three quantities were calculated as discussed below.

The first is CO conversion, X_{CO}, which is defined similarly to that in the PrOx reactor, and evaluated by the CO concentration entering and exiting the ECPrOx unit,

$${X}_{CO} = \frac{{f}_{in} {x}_{CO , in} - {f}_{out} {x}_{CO}}{{f}_{in} {x}_{CO , in}}$$

where fᵢₙ and fₒᵤₜ are the total molar flow rates at inlet and outlet, respectively, and x_{CO,in} and x_{CO} are the CO mole fractions in the inlet and outlet gas stream.

In ECPrOx unit, a pre-determined (by selected current density) amount of hydrogen is consumed to generate current and polarize the anode. Meanwhile, CO electrooxidation contributes to the total Faradiac current drawn from the ECPrOx unit as well. Thus, the fraction of CO electro-oxidation current in the total Faradaic current, β_{F}^{CO}, is defined as

$${β}_{F}^{CO} = \frac{{i}_{CO}}{{i}_{CO} + {i}_{{H}_{2}}} = \frac{2 F {f}_{in}^{CO} {X}_{CO}}{I}$$

where fᵢₙ^{CO} is the inlet molar flow rate of CO, F is the Faradaic constant, and I is the total current.

In principle, if the CO concentration is high enough, the ratio could approach one, i.e., almost all the Faradaic current and anode polarization is contributed from CO electro-oxidation. In this sense, CO is viewed as a fuel instead of a poison.

The last factor to consider is the hydrogen recovery, defined as the ratio between the inlet and outlet hydrogen molar flow rate,

$${ɛ}_{{H}_{2}} = \frac{{f}_{out}^{{H}_{2}}}{{f}_{in}^{{H}_{2}}} = \frac{{f}_{in}^{{H}_{2}} - I ( 1 - {β}_{F}^{CO} ) / 2 F}{{f}_{in}^{{H}_{2}}}$$

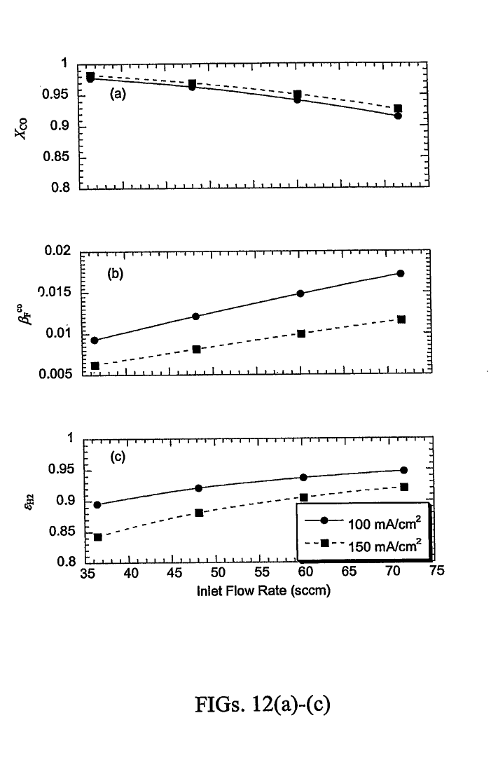

These three values (X_{CO}, β_{F}^{CO} and ε_{H2}) were calculated using experimental results obtained by an electrochemical device of the invention where 1000 ppm CO feed was employed. The calculated values are represented in FIGS. 12(a)-(c). As shown in FIG. 12(a), the calculated CO conversion decreased from 98% to 92% with the increase of inlet flow rates. This was due to the fact that the cell voltage did not change appreciably with inlet flow rates. Even though the CO electrooxidation rate might be increased with the increase of inlet flow rates, the increased CO consumption could not counterbalance the faster input of CO by the higher flow rates.

As shown in FIG. 12(b), for an anode feed containing 1000 ppm CO, the CO contribution in the overall current was only about 0.6 to 2%. The ratio of CO electrooxidation current in the total current increased with the inlet flow rates.

As shown in FIG. 12(c), the recovery of hydrogen was predominantly determined by the operating current at a certain inlet flow rate. For a current density of 100 mA/cm², the hydrogen recovery was between 90 to 95% in the flow rates investigated. The recovery increased with the inlet flow rate for a given current density.

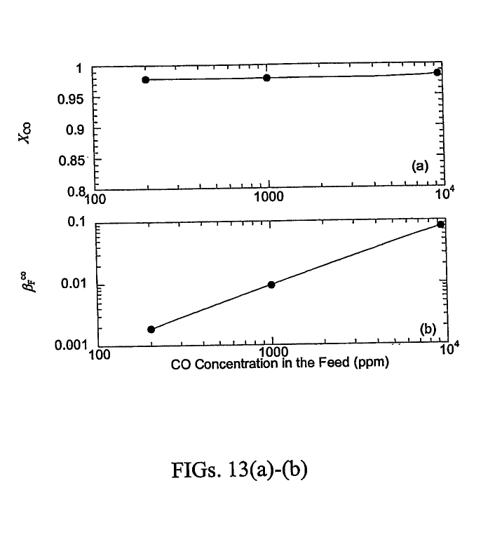

The CO conversion (FIG. 13(a)) and CO contribution to the overall current (FIG. 13(b)) in the ECPrOx unit of the invention at 100 mA/cm² and a flow rate of 36.4 sccm were also calculated. Catalyst loading in the ECPrOx unit was 0.7 mg/cm². As shown in FIG. 13(a), the calculated conversion of CO was nearly independent of the feed concentration, which indicated that unit was self-regulated and naturally stable. The CO electrooxidation current increased with the CO concentration in the feed, as shown in FIG. 13(b). For a feed containing 9380 ppm CO, the contribution of CO electrooxidation had increased to almost 10%, which was a substantial fraction of the total current drawn from the ECPrOx unit. If this trend is extrapolated, then higher feed CO concentration can contribute even more substantially to the total current by CO electrooxidation. Thus, CO can be viewed as a fuel instead of poison and it may be possible to eliminate the LTS stage.

### EQUIVALENTS

While this invention has been particularly shown and described with references to preferred embodiments thereof, it will be understood by those skilled in the art that various changes in form and details may be made therein without departing from the scope of the invention encompassed by the appended claims.

1. An electrochemical device, comprising:
(A) a first electrochemical reactor that includes:
(a) a single or multiple electrochemical cells, each of the cells including:
an anode compartment, including an anode first gas inlet, an anode and an anode first gas outlet;
a cathode compartment, including a cathode second gas inlet, a cathode and a cathode second gas outlet; and
an ion-selective partition between the anode and cathode;
(b) a first gas inlet and a first gas outlet in fluid communication with the anode compartment of each of the cells;
(c) a second gas inlet and a second gas outlet in fluid communication with the cathode compartment of each of the cells; and
(d) a galvanostat in electrical communication with the anode and cathode of each of the electrochemical cells; and
(B) a gas source in fluid communication with the anode compartment or cathode compartment of each of the electrochemical cells, including at least two components that are selectively reactive relative to each other, the selectivity being dependent upon an electrical potential between the anode and cathode, whereby a constant current between the anode and cathode causes the electrical potential to oscillate autonomously while the gas components are directed through said anode compartment or cathode compartment, the oscillation in potential causing autonomous oscillation of selective reaction of the gas components, and
(C) a fuel cell system that includes a single fuel cell or a stack of fuel cells, each of the fuel cells including an anode compartment, a cathode compartment and a proton-exchange membrane between the anode and cathode compartments, wherein the first or second gas outlet of the electrochemical reactor is in fluid communication with the fuel cell system.

2. The device of claim 1, wherein the gas source is in fluid communication with the anode compartment of each of the electrochemical cells.

3. The device of claim 2, wherein the first gas outlet of the electrochemical device is in fluid communication with the anode compartment of the fuel cell system.

4. The device of claim 3, wherein the gas source includes carbon monoxide.

5. The device of claim 4, wherein the gas source includes carbon monoxide in a concentration at least 50 ppm.

6. The device of claim 4, wherein the fuel cell is selected from the group consisting of a proton-exchange membrane fuel cell, a phosphoric acid fuel cell, an alkaline fuel cell, a molten carbonate fuel cell and a solid oxide fuel cell.

7. The device of claim 6, wherein the ion-selective partition of each of the electrochemical cells independently is selected from a proton-exchange membrane, a hydroxide solution, phosphoric acid, molten carbonate and a solid oxide.

8. The device of claim 7, wherein the gas source is a CO-containing, hydrogen-rich reformate source.

9. The device of claim 8, wherein the fuel cells are a proton-exchange membrane fuel cell.

10. The device of claim 9, wherein the ion-selective partition is a proton-exchange membrane.

11. The device of claim 10, the anode and cathode of each of the electrochemical cells are each independently gas diffusion electrodes.

12. The device of claim 11, the gas diffusion electrodes for the anode and cathode each independently comprise a catalyst that includes at least one element selected from the group consisting of Pt, Ru, Pd, Rh, Ir, Fe, Co, Cr, Cu, Ag, Ni, Mo and Au.

13. The device of claim 12, wherein each of the catalysts for the anode and cathode independently further includes at least one element selected from the group consisting of carbon black, Al₂O₃, an oxide of manganese, an oxide of cobalt, an oxide of nickel, AgO and a mixture thereof.

14. The device of claim 12, wherein the proton-exchange membrane includes a solid polymer.

15. The device of claim 14, wherein the solid polymer is selected from the group consisting of a perfluorinated ionomer, polybenzimidazole and sulfonated polyether ether ketone.

16. The device of claim 15, wherein the solid polymer is a perfluorinated ionomer, reinforced with poly(tetrafluoroethylene).

17. The device of claim 14, wherein the galvanostat is set at a value in a range of between about 30 mA/cm² and about 700 mA/cm².

18. The device of claim 14, further including a CO and/or CO₂ gas analyzer in fluid communication with the first gas outlet of the electrochemical reactor.

19. The device of claim 18, further including a rechargeable battery connected to the reactor, whereby power output of the reactor is stored in the battery.

20. The device of claim 18, wherein the power output of the electrochemical reactor is integrated into the power output of the fuel cell system.

21. The device of claim 9, further including a second electrochemical reactor that includes:
(a) a single or multiple electrochemical cells, each of the cells including:
an anode compartment, including an anode first gas inlet, an anode and an anode first gas outlet;
a cathode compartment, including a cathode second gas inlet, a cathode and a cathode second gas outlet; and
an ion-selective partition between the anode and cathode;
(b) a first gas inlet and a first gas outlet in fluid communication with the anode compartment of each of the cells;
(c) a second gas inlet and a second gas outlet in fluid communication with the cathode compartment of each of the cells; and
(d) a galvanostat in electrical communication with the anode and cathode of each of the electrochemical cells,
wherein the first gas outlet of the first electrochemical reactor is in fluid communication with the first gas inlet of the second electrochemical reactor, and wherein the first gas outlet of the second electrochemical reactor is in fluid communication with the anode compartment of the fuel cell system.

22. The device of claim 21, wherein the ion-selective partition of each of the electrochemical cells in the second electrochemical reactor is selected from a proton-exchange membrane, a hydroxide solution, phosphoric acid, molten carbonate and solid oxide.

23. The device of claim 22, wherein the ion-selective partition of each of the electrochemical cells in the second electrochemical reactor is a proton-exchange membrane.

24. The device of claim 23, the anode and cathode of each of the electrochemical cells in the second electrochemical reactor are gas diffusion electrodes.

25. The device of claim 24, the gas diffusion electrodes for the anode and cathode each independently comprise a catalyst that includes at least one element selected from the group consisting of Pt, Ru, Pd, Rh, Ir, Fe, Co, Cr, Cu, Ag, Ni, Mo and Au.

26. The device of claim 25, wherein the galvanostat of the second electrochemical reactor is set at a value in a range of between about 30 mA/cm² and about 700 mA/cm².

27. The device of claim 25, further including a CO and/or CO₂ gas analyzer in fluid communication with the first gas outlet of the second reactor.

28. The device of claim 26, further including a rechargeable battery connected to the first and second reactors, whereby power output of the reactors is stored in the battery.

29. The device of claim 26, wherein the power output of the electrochemical reactors is integrated into the power output of the fuel cell system.

30. A method of purifying a gas, comprising the steps of:
directing the gas from a gas source through an anode compartment or cathode compartment of an electrochemical reactor, wherein the electrochemical reactor further includes:
an ion-selective partition between the anode compartment and cathode compartment; and
a galvanostat in electrical communication with an anode of the anode compartment and a cathode of the cathode compartment,
and wherein the gas includes at least two components that are selectively reactive relative to each other, the selectivity being dependent upon an electrical potential between the anode and cathode, whereby a constant current between the anode and cathode causes the electrical potential to oscillate autonomously while the gas is directed through the anode compartment or cathode compartment, the oscillation in potential causing autonomous oscillation of selective reaction of the gas components that predominantly removes one of the two components, thereby purifying the gas; and
directing the purified gas through an anode compartment or a cathode compartment of a fuel cell system that includes a single fuel cell or a stack of fuel cells.

31. The method of claim 30, wherein the gas is directed through the anode compartment of the electrochemical reactor.

32. The method of claim 31, wherein the purified gas is directed through the anode compartment of the fuel cell system.

33. The method of claim 32, wherein the gas source includes carbon monoxide.

34. The method of claim 33, wherein the gas source includes carbon monoxide in a concentration at least 50 ppm.

35. The method of claim 33, wherein the fuel cell is selected from the group consisting of a proton-exchange membrane fuel cell, a phosphoric acid fuel cell, an alkaline fuel cell, a molten carbonate fuel cell and a solid oxide fuel cell.

36. The method of claim 35, wherein the ion-selective partition of the electrochemical reactor is selected from a proton-exchange membrane, a hydroxide solution, phosphoric acid, molten carbonate and solid oxide.

37. The method of claim 36, wherein the gas is a CO-containing, hydrogen-rich reformate.

38. The method of claim 37, wherein carbon monoxide is selectively removed from the reformate.

39. The method of claim 38, wherein the fuel cell is a proton-exchange membrane fuel cell.

40. The method of claim 39, the anode and cathode of the electrochemical reactor are each independently a gas diffusion electrode.

41. The method of claim 40, wherein the gas diffusion electrodes for the anode and cathode of the reactor each independently comprises a catalyst that includes at least one element selected from the group consisting of Pt, Ru, Pd, Rh, Ir, Fe, Co, Cr, Cu, Ag, Ni, Mo and Au.

42. The method of claim 41, wherein each of the catalysts for the anode and cathode independently further includes at least one element selected from the group consisting of carbon black, Al₂O₃, an oxide of manganese, an oxide of cobalt, an oxide of nickel, AgO and a mixture thereof.

43. The method of claim 42, wherein the proton-selective partition is a proton-exchange membrane.

44. The method of claim 43, wherein the proton-exchange membrane includes a solid polymer.

45. The method of claim 44, wherein the solid polymer is selected from the group consisting of a perfluorinated ionomer, polybenzimidazole and sulfonated polyether ether ketone.

46. The method of claim 44, the gas is directed through the anode compartment at a temperature in a range of between about 10° C. and about 80° C.

47. The method of claim 44, wherein the galvanostat is set at a value in a range of between about 30 mA/cm² and about 700 mA/cm².

48. The method of claim 45, wherein the solid polymer is a perfluorinated ionomer, reinforced with poly(tetrafluoroethylene).

49. A method of purifying a gas that includes CO and hydrogen, comprising the step of:
directing the gas from a gas source through an anode compartment of an electrochemical reactor, wherein the electrochemical reactor further includes:
an ion-selective partition between the anode compartment and cathode compartment; and
a galvanostat in electrical communication with an anode of the anode compartment and a cathode of the cathode compartment,
and wherein selectivity of reaction of CO and hydrogen at the anode compartment is dependent upon an electrical potential between the anode and cathode, whereby a constant current between the anode and cathode causes the electrical potential to oscillate autonomously while the gas is directed through the anode compartment, the oscillation in potential causing autonomous oscillation of selective reaction of CO and hydrogen that predominantly removes CO, thereby purifying the gas.
